(19) United States
(12) Patent Application Publication
(10) Pub. No.: US 2006/0099138 A1
(43) Pub. Date: May 11, 2006

(54) Method for producing chlorine from hydrochloric from hydrochloric aid

(75) Inventors: Christian Walsdorff, Ludwigshafen (DE); Martin Fiene, Niederkirchen (DE); Christian Kuhrs, Heidelberg (DE); Eckhard Stroefer, Mannheim (DE); Klaus Harth, Tai Tam (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/532,725

(22) PCT Filed: Oct. 27, 2003
(86) PCT No.: PCT/EP03/11910

§ 371 Date: Apr. 27, 2005

(30) Foreign Application Priority Data
Oct. 28, 2002 (DE) 102 50 131.9

(51) Int. Cl. C01B 7/00

(52) U.S. Cl. 423/502

(57) ABSTRACT

Process for preparing chlorine from hydrochloric acid, which comprises the steps: a) providing a hydrochloric acid feed stream I; b) providing a hydrochloric acid recycle stream II; c) separating off a hydrogen chloride stream IV from the hydrochloric acid feed stream I and the hydrochloric acid recycle stream II in a distillation step; d) feeding the hydrogen chloride stream IV, an oxygen-containing steam V and, if desired, an oxygen-containing recycle stream Va into an oxidation zone and oxidizing hydrogen chloride to chlorine in the presence of a catalyst to give a product gas stream VI comprising chlorine, unreacted oxygen, unreacted hydrogen chloride and water vapor; e) separating off hydrogen chloride and water from the product gas stream VI in an absorption step to give a gas stream VII and the hydrochloric acid recycle stream II; f) if desired, drying the gas stream VII; g) separating off an oxygen-containing stream from the gas stream VII and, if desired, recirculating at least part of this as oxygen-containing recycle stream Va to the oxidation zone, leaving a chlorine-containing product stream VIII; h) if desired, further purifying the chlorine-containing product stream VIII.

The invention relates to a process for preparing chlorine from hydrochloric acid.

In the process developed by Deacon in 1868 for the catalytic oxidation of hydrogen chloride, hydrogen chloride is oxidized by oxygen to form chlorine in an exothermic equilibrium reaction. Conversion of hydrogen chloride into chlorine enables chlorine production to be decoupled from sodium hydroxide production by chloralkali electrolysis. Such decoupling is attractive since the global demand for chlorine is growing faster than the demand for sodium hydroxide. In addition, hydrogen chloride is formed in large amounts as coproduct in, for example, phosgenation reactions such as the preparation of isocyanates. The hydrogen chloride formed in the preparation of isocyanates is used predominantly in the oxychlorination of ethylene to 1,2-dichloroethane which is further processed to give vinyl chloride and finally PVC.

The hydrogen chloride used in the Deacon reaction is usually provided in gaseous form. It is frequently gaseous hydrogen chloride which is obtained as coproduct in other syntheses, for example in the preparation of isocyanates.

However, it may be the case that at isolated production sites there is no gaseous hydrogen chloride available via gas pipelines from other processes. Hydrochloric acid, for example from railroad tank cars, then has to be employed. Furthermore, a process by means of which the aqueous hydrochloric acid obtained at other sites can be utilized is sought.

It is an object of the invention to provide an advantageous process for preparing chlorine from hydrogen chloride in which the hydrogen chloride is not used in gaseous form but at least partly in the form of hydrochloric acid.

We have found that this object is achieved by a process for preparing chlorine from hydrochloric acid, which comprises the steps:
a) providing a hydrochloric acid feed stream I;
b) providing a hydrochloric acid recycle stream II;
c) separating off a hydrogen chloride stream IV from the hydrochloric acid feed stream I and the hydrochloric acid recycle stream II in a distillation step;
d) feeding the hydrogen chloride stream IV, an oxygen-containing stream V and, if desired, an oxygen-containing recycle stream Va into an oxidation zone and oxidizing hydrogen chloride to chlorine in the presence of a catalyst to give a product gas stream VI comprising chlorine, unreacted oxygen, unreacted hydrogen chloride and water vapor;
e) separating off hydrogen chloride and water from the product gas stream VI in a quenching and/or absorption step to give a gas stream VII and the hydrochloric acid recycle stream II;
f) if desired, drying the gas stream VII;
g) separating off an oxygen-containing stream from the gas stream VII and, if desired, recirculating at least part of this as oxygen-containing recycle stream Va to the oxidation zone, leaving a chlorine-containing product stream VIII;
h) if desired, further purifying the chlorine-containing product stream VIII.

Liquid hydrochloric acid feed streams can easily be processed by means of the process of the present invention. In the distillation step c), a hydrogen chloride stream is obtained at the top of the column. This is at the pressure prevailing at the temperature T at the top, usually from about 2 to 20 bar. The pressure is sufficiently high to feed the hydrogen chloride stream into the hydrogen chloride oxidation reactor without requiring the use of additional compressors.

The hydrochloric acid feed stream I is preferably obtained by
a1) preparing a feed gas stream Ia which comprises hydrogen chloride and may contain secondary constituents which are not soluble in water;
a2) absorbing hydrogen chloride in water in an absorption step to give the hydrochloric acid feed stream I and possibly an offgas stream III comprising impurities which are not soluble in water.

The feed gas stream Ia comprising hydrogen chloride which is used in the process step a1) is preferably an HCl-containing stream obtained as offgas stream in a process in which hydrogen chloride is formed as coproduct. Examples of such processes are
(1) isocyanate production from phosgene and amines,
(2) acid chloride production,
(3) polycarbonate production,
(4) preparation of vinyl chloride from ethylene dichloride,
(5) chlorination of aromatics.

The feed gas stream Ia comprising hydrogen chloride can contain secondary constituents. It usually contains impurities which are not soluble in water and may be either organic or inorganic in nature. Examples of organic impurities are hydrocarbons and chlorinated hydrocarbons.

Typical hydrocarbons which may be present in the feed gas streams comprising hydrogen chloride which are used according to the present invention include aromatics such as benzene, toluene, xylenes and C₆-C₁₂-aliphatics. Typical chlorinated hydrocarbons include phosgene, carbon tetrachloride, vinyl chloride and dichloroethane. The hydrocarbons and chlorinated hydrocarbons can be present in amounts of up to 20% by volume, in general up to 30 000 ppm, preferably in amounts up to 10 000 ppm and in particular in amounts of from 100 to 3000 ppm. Inorganic secondary constituents which may be present are, for example, carbon monoxide, carbon dioxide, nitrogen and further inert gases, generally in amounts of up to 10% by volume, preferably in amounts of up to 1% by volume.

In an absorption step a2), hydrogen chloride is absorbed in water to give a stream of dilute hydrochloric acid as hydrochloric acid feed stream I and possibly an offgas stream III comprising the impurities which are not soluble in water. The absorption step a2) is usually carried out by means of a gas scrubber in which hydrogen chloride is scrubbed from the feed gas stream as aqueous hydrochloric acid.

In a distillation step c), a hydrogen chloride stream IV is separated off from the hydrochloric acid feed stream I and the hydrochloric acid recycle stream II. This can be achieved by combining the hydrochloric acid streams I and II and fractionating them together in a distillation column to give a hydrogen chloride stream IV and a stream IIa comprising azeotropic hydrochloric acid. The distillation is usually carried out at a pressure of from 1 to 20 bar, preferably at a pressure of from 2 to 15 bar. The distillation step c) can be carried out in a customary distillation column. This should be corrosion-resistant. At the top of the distillation column, an essentially anhydrous hydrogen chloride stream IV is obtained. A stream IIa comprising azeotropic dilute hydrochloric acid is obtained at the bottom of the column, with the HCl concentration of the azeotropic hydrochloric acid being dependent on the column pressure. The HCl concentration of the azeotropic hydrochloric acid of stream IIa is usually from 10 to 25% by weight.

In a preferred embodiment of the process of the present invention, the distillation step c) is carried out by fractionating the hydrochloric acid streams I and II in a first substep c1) to give a hydrogen chloride stream IV and an azeotropic hydrochloric acid stream IIa and fractionating the azeotropic hydrochloric acid stream IIa in a second substep c2) to give a water vapor stream IX and a hydrochloric acid stream IIb having a concentration higher than that of the hydrochloric acid stream IIa and recirculating the hydrochloric acid stream IIb to the substep c1), with the first substep c1) being carried out at a higher pressure than the second substep c2). The distillation steps c1) and c2) are carried out in customary distillation columns.

The hydrogen chloride stream IV is fed to the catalytic hydrogen chloride oxidation. The pressure of the hydrogen chloride stream IV on leaving the distillation column is usually from 2 to 30 bar and is thus generally sufficiently high for a compressor to be unnecessary for recirculation of the hydrogen chloride to the catalytic hydrogen chloride oxidation.

In an oxidation step d), the hydrogen chloride stream IV, an oxygen-containing stream V and, if desired, an oxygen-containing recycle stream Va are fed into an oxidation zone and hydrogen chloride is oxidized to chlorine in the presence of a catalyst to give a product gas stream VI comprising chlorine, unreacted oxygen, unreacted hydrogen chloride and water vapor.

In the catalytic process also known as the Deacon process, hydrogen chloride is oxidized by oxygen to form chlorine in an exothermic equilibrium reaction which also forms water vapor. Customary reaction temperatures are from 150 to 500° C., and customary reaction pressures are from 1 to 25 bar. It is also advantageous to use oxygen in superstoichiometric amounts. For example, a two-fold to four-fold excess of oxygen is customarily employed. Since no losses of selectivity have to be feared, it can be economically advantageous to work at relatively high pressures and accordingly at residence times which are longer than at atmospheric pressure. Suitable catalysts comprise, for example, ruthenium oxide, ruthenium chloride or other ruthenium compounds on silicon dioxide, aluminum oxide, titanium dioxide or zirconium dioxide as support. Suitable catalysts can be obtained, for example, by application of ruthenium chloride to the support and subsequent drying or drying and calcination. Suitable catalysts can also comprise compounds of other noble metals, for example gold, palladium, platinum, osmium, iridium, silver, copper or rhenium, in addition to or in place of a ruthenium compound. Suitable catalyst may further comprise chromium(III) oxide.

Further suitable catalysts are ones which comprise a support and, applied to it, from 0.001 to 30% by weight of gold, from 0 to 3% by weight of one or more alkaline earth metals, from 0 to 3% by weight of one or more alkali metals, from 0 to 10% by weight of one or more rare earth metals and from 0 to 10% by weight of one or more further metals selected from the group consisting of ruthenium, palladium, platinum, osmium, iridium, silver, copper and rhenium, in each case based on the total weight of the catalyst.

Such gold-containing supported catalysts have, particularly at temperatures of ≦250° C., a higher activity in the oxidation of hydrogen chloride than do the ruthenium-containing catalysts of the prior art.

Customary reaction apparatuses in which the catalytic hydrogen chloride oxidation is carried out are fixed-bed and fluidized-bed reactors. The hydrogen chloride oxidation can be carried out in a plurality of stages.

The catalytic hydrogen chloride oxidation can be carried out adiabatically or preferably isothermally or approximately isothermally, batchwise but preferably continuously as a moving-bed or fixed-bed process, preferably as a fixed-bed process, particularly preferably in shell-and-tube reactors over heterogeneous catalysts at reactor temperatures of from 180 to 500° C., preferably from 200 to 400° C., particularly preferably from 220 to 350° C., and a pressure of from 1 to 25 bar, preferably from 1.2 to 20 bar, particularly preferably from 1.5 to 17 bar and in particular from 2.0 to 15 bar.

In an isothermal or approximately isothermal process, it is also possible to use a plurality of reactors, i.e. from 2 to 10, preferably from 2 to 6, particularly preferably from 2 to 5, in particular 2 or 3, reactors connected in series with additional intermediate cooling. The oxygen can either all be added together with the hydrogen chloride upstream of the first reactor or the addition can be distributed over the various reactors. This series arrangement of individual reactors can also be combined in one apparatus.

In a preferred embodiment, use is made of a structured catalyst bed in which the catalyst activity increases in the direction of flow. Such structuring of the catalyst bed can be achieved by different impregnation of the catalyst supports with active composition or by different dilution of the catalyst with inert material. Inert materials which can be used are, for example, rings, cylinders or spheres of titanium dioxide, zirconium dioxide or mixtures thereof, aluminum oxide, steatite, ceramic, glass, graphite or stainless steel. In the case of the preferred use of shaped catalyst bodies, the inert material preferably has similar external dimensions.

Any shapes are suitable as shaped catalyst bodies, and preference is given to pellets, rings, cylinders, stars, wagon wheels or spheres, particularly preferably rings, cylinders or star extrudates.

Suitable heterogeneous catalysts are, in particular, ruthenium compounds or copper compounds on support materials and may also be doped. Preference is given to doped or undoped ruthenium catalysts. Suitable support materials are, for example, silicon dioxide, graphite, titanium dioxide having a rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof.

The supported copper or ruthenium catalysts can be obtained, for example, by impregnation of the support material with aqueous solutions of CuCl₂ or RuCl₃ and if desired a promoter for doping, preferably in the form of its chlorides. Shaping of the catalyst can be carried out after or preferably before impregnation of the support material.

Suitable promoters for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can subsequently be dried and if desired calcined at from 100 to 400° C., preferably from 100 to 300° C., for example under a nitrogen, argon or air atmosphere. The shaped bodies are preferably firstly dried at from 100 to 150° C. and subsequently calcined at from 200 to 400° C.

The conversion of hydrogen chloride in a single pass can be restricted to from 15 to 90%, preferably from 40 to 85%, particularly preferably from 50 to 80%. Unreacted hydrogen chloride can be separated off and recirculated in part or in its entirety to the catalytic hydrogen chloride oxidation. The volume ratio of hydrogen chloride to oxygen at the reactor inlet is generally from 1:1 to 20:1, preferably from 2:1 to 8:1, particularly preferably from 2:1 to 5:1.

In a quenching and/or absorption step e), hydrogen chloride and water are separated off from the product gas stream VI to give a gas stream VII and a stream II of dilute hydrochloric acid. Suitable absorption media are water and any dilute hydrochloric acid which is not saturated with hydrogen chloride. Preference is given to using water as absorption medium. The absorption temperature is usually from 0 to 150° C., preferably from 30 to 100° C., and the absorption pressure is usually from 0.5 to 20 bar, preferably from 1 to 10 bar.

A gas stream VII which comprises chlorine and oxygen or consists essentially of these gases is obtained. It usually still contains traces of moisture. It is therefore usual to carry out a drying step f) in which the gas stream comprising chlorine and oxygen is freed of traces of moisture by bringing it into contact with suitable desiccants. Suitable desiccants are, for example, concentrated sulfuric acid, molecular sieves or hygroscopic adsorbents.

In a separation step g), an oxygen-containing stream is separated off from the gas stream VII and this may be recirculated at least partly as oxygen-containing recycle stream Va to the oxidation zone. This leaves a chlorine-containing product stream VIII.

The oxygen is preferably separated off by distillation, usually at a temperature in the range from −20 to +50° C. and a pressure in the range from 1 to 20 bar in a distillation column having from 10 to 100 theoretical plates.

The chlorine-containing product stream VII can be purified further.

In a preferred embodiment, the feed gas stream I comprising hydrogen chloride is obtained in the synthesis of isocyanates from phosgene and primary amines.

In a particularly preferred embodiment of the invention, the feed gas stream I comprising hydrogen chloride is obtained in the synthesis of isocyanates from phosgene and primary amines and the chlorine-containing product gas stream VIII is used for the preparation of the phosgene which is subsequently reacted with the primary amines to form isocyanates.

The present invention therefore also provides an integrated process for preparing organic isocyanates, which comprises the steps
i) providing a feed gas stream X comprising carbon monoxide, a chlorine-containing recycle stream VIII and, if desired, a chlorine-containing supplementary stream VIIIa;
ii) reacting the streams X, VIII and, if used, VIIIa in a phosgene synthesis step to give a phosgene-containing gas stream XI;
iii) reacting the phosgene-containing gas stream XI with or more primary amines in an isocyanate synthesis step to form the corresponding isocyanate(s) and hydrogen chloride and give a gas stream XII comprising hydrogen chloride and unreacted phosgene and an isocyanate-containing product stream XIII;
iv) fractionating the gas stream XII comprising hydrogen chloride and unreacted phosgene in a fractionation step to give a gas stream Ia comprising hydrogen chloride and possibly impurities which are not soluble in water and a phosgene-containing stream XIV, and, if desired, recirculating the phosgene-containing stream XIV to the isocyanate synthesis step iii);
v) absorbing hydrogen chloride from the gas stream Ia in water in an absorption step to give a hydrochloric acid feed stream I comprising dilute hydrochloric acid and possibly an offgas stream III comprising the impurities which are not soluble in water;
vi) separating off a hydrogen chloride stream IV from the hydrochloric acid feed stream I and a hydrochloric acid recycle stream II in a distillation step;
vii) feeding the hydrogen chloride stream IV, an oxygen-containing stream V and, if desired, an oxygen-containing recycle stream Va into an oxidation zone and oxidizing hydrogen chloride in the presence of a catalyst to form chlorine and give a product gas stream VI comprising chlorine, unreacted oxygen, unreacted hydrogen chloride and water vapor;
viii) separating off hydrogen chloride and water from the product gas stream VI in an absorption step to give a gas stream VII and a hydrochloric acid recycle stream II comprising dilute hydrochloric acid;
ix) drying the gas stream VII;
x) separating off an oxygen-containing stream from the gas stream VII and, if desired, recirculating at least part of this as oxygen-containing recycle stream Va to the oxidation zone to leave a chlorine-containing product stream VIII;
xi) using the chlorine-containing product stream VIII, if desired after purification, as chlorine-containing recycle stream VIII in step i).

In step i), a feed gas stream X comprising carbon monoxide, a chlorine-containing stream VIII as recycle stream VIII and, if desired, a chlorine-containing supplementary stream VIIIa to make up chlorine losses are provided.

In a phosgene synthesis step ii), the streams X, VIII and, if used, VIIIa are reacted to give a phosgene-containing gas stream XI. Processes for preparing phosgene are described in Ullmanns Enzyklopädie der Industriellen Chemie, 3rd Edition, Vol. 13, pages 494-500. Thus, phosgene can be obtained by passing carbon monoxide and chlorine over activated carbon.

In an isocyanate synthesis step iii), the phosgene-containing gas stream XI is reacted with one or more primary amines to form the corresponding isocyanate(s) and hydrogen chloride and give a gas stream XII comprising hydrogen chloride and unreacted phosgene and an isocyanate-containing product stream XIII. This reaction is also known as phosgenation of the amines. The amines used have at least one, preferably two and possibly also three or more, primary amino group(s).

The preparation of isocyanates taking place in the process of the present invention is carried out in a manner known to those skilled in the art by reacting an amine or a mixture of two or more amines with a superstoichiometric amount of phosgene. It is in principle possible to employ all processes in which a primary amine or a mixture or two or more primary amines having one or more primary amino groups is reacted with phosgene to form one or more isocyanates having one or more isocyanate groups.

In a preferred embodiment of the invention, the phosgenation of the amine or amines is carried out in a solvent or solvent mixture. All solvents suitable for the preparation of isocyanates can be used as solvent. These are preferably inert aromatic, aliphatic or alicyclic hydrocarbons or their halogenated derivatives. Examples of such solvents are aromatic compounds such as monochlorobenzene or dichlorobenzene, for example o-dichlorobenzene, toluene, xylenes, naphthalene derivatives such as tetralin or decalin, alkanes having from about 5 to about 12 carbon atoms, e.g. hexane, heptane, octane, nonane or decane, cycloalkanes such as cyclohexane, largely inert esters and ethers such as ethyl acetate or butyl acetate, tetrahydrofuran, dioxane or diphenyl ether. A substream of the isocyanate produced can also be recirculated as solvent or solvent constituent.

As amines, it is in principle possible to use all primary amines which are able to react in an appropriate manner with phosgene to form isocyanates. All linear or branched, saturated or unsaturated aliphatic or cycloaliphatic or aromatic primary monoamines or polyamines which can be reacted with phosgene to form isocyanates are suitable in principle. Examples of suitable amines are 1,3-propylenediamine, 1,4-butylenediamine, 1,5-pentamethylenediamine, 1,6-hexamethylenediamine and the corresponding higher homologues of this series, isophoronediamine (IPDA), cyclohexylenediamine, cyclohexylamine, aniline, phenylenediamine, p-toluidine, 1,5-naphthylenediamine, 2,4- or 2,6-toluenediamine or mixtures thereof, 4,4′-, 2,4′- or 2,2′-diphenyl-methanediamine or mixtures thereof, and also higher molecular weight isomeric, oligomeric or polymeric derivatives of the abovementioned amines and polyamines.

In a preferred embodiment of the present invention, the amines used are the isomeric primary diphenylmethanediamines (MDA) or their oligomeric or polymeric derivatives, i.e. the amines of the diphenylmethanediamine series. Diphenylmethanediamine and its oligomers or polymers are obtained, for example, by condensation of aniline with formaldehyde. Such oligoamines or polyamines or mixtures thereof are also used in a preferred embodiment of the invention. Further preferred amines are hexamethylenediamine, toluenediamine and isophorone-diamine.

The reaction of phosgene with the abovementioned amines can be carried out continuously or batchwise in one or more stages. If a single-stage reaction is carried out, it is preferably carried out at from about 40 to 200° C., for example from about 90 to 180° C.

In a preferred embodiment of the invention, the reaction is carried out in two stages. Here, the first stage, also known as cold phosgenation, comprises reacting phosgene with the amine or amines at from 0 to 160° C., for example from 20 to 130° C., for a period of from about 0.5 minutes to 2 hours. In a second stage, also known as hot phosgenation, the temperature is increased over a period of generally from about 1 minute to 5 hours, for example over a period of from about 1 minute to 3 hours, to 60-190° C., in particular 70-170° C.

In a further embodiment of the invention, superatmospheric pressure, generally up to 100 bar or less, preferably from 1 bar to about 50 bar, particularly preferably from 2 bar to 25 bar, in particular from 3 bar to 12 bar, can be applied during the reaction. In a further embodiment of the invention, the reaction is carried out at about 1 bar (ambient pressure). In a further embodiment, a pressure reduced below ambient pressure is employed.

The phosgenation gives an isocyanate-containing product stream XIII from which the isocyanates formed are subsequently separated off and are purified if required.

Excess phosgene can be removed at from 50 to 180° C. subsequent to the reaction. The removal of the solvent is preferably carried out under reduced pressure, for example at a pressure of 500 mbar or less, preferably 100 mbar or less. In general, the various solvent components are separated off in the order of their boiling points, but it is also possible to separate off mixtures of the various components in a single process step. The isocyanate obtained can subsequently be fractionated.

In a fractionation step iv), a gas stream Ia comprising hydrogen chloride and possibly impurities which are not soluble in water and a phosgene-containing stream XIV are obtained from the gas stream XII comprising hydrogen chloride and unreacted phosgene, and the phosgene-containing stream XIV is, if desired, recirculated to the isocyanate synthesis step iii). In the reaction iii) of phosgene with amine, hydrogen chloride is usually obtained in gaseous form in admixture with phosgene and, typically, small amounts of further gases such as carbon monoxide, carbon dioxide, nitrogen and traces of solvents used in the isocyanate synthesis. Phosgene and high-boiling secondary constituents can be separated off by distillation. This gives a stream consisting essentially of hydrogen chloride. Traces of organic impurities such as phosgene and solvent residues present therein can be removed in a downstream purification step by absorption, adsorption, distillation or extraction.

However, it is simpler to purify the hydrogen chloride stream by absorption in water or dilute hydrochloric acid, leaving the gas constituents which are not soluble in water in the tailgas stream.

Accordingly, hydrogen chloride is separated from the gas stream Ia by absorption in water in an absorption step v) to give a stream I comprising dilute hydrochloric acid and possibly an offgas stream III comprising the impurities which are not soluble in water.

Before carrying out the absorption step v), the stream Ia comprising hydrogen chloride can be prepurified by passing it over a purification bed so as to absorb solvent residues present in it on the purification bed. The purification bed comprises suitable absorbents, preferably in the form of shaped bodies such as spheres, extrudates or pellets. Materials suitable as absorbents are, for example, activated carbon, aluminum oxide, titanium oxide, silicon dioxide, iron oxide, zeolites and molecular sieves. Suitable materials may also comprise metal oxides or metal halides, e.g. copper or ruthenium oxides or halides or mixtures thereof, on a support comprising a refractory organic material such as aluminum oxide, titanium oxide or silicon dioxide. Preferred absorbents are aluminum oxide, activated carbon and clays.

A stream I comprising dilute hydrochloric acid is obtained. This stream, too, can be further purified. The subsequent steps vi) to xi) of the process of the present invention for preparing organic isocyanates correspond to the above-described steps c) to g) of the process of the present invention for preparing chlorine.

The invention is illustrated by the figures.

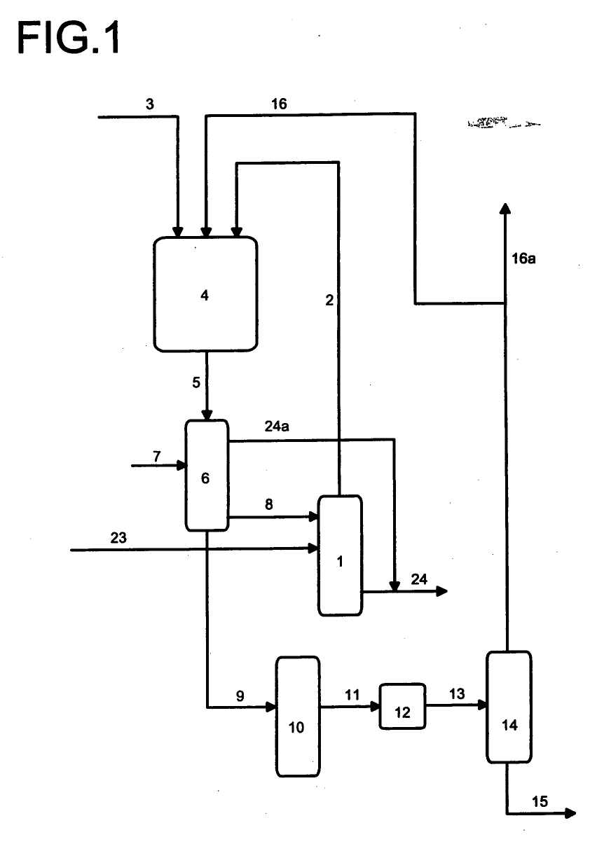

FIG. 1 shows, by way of example, a variant of the process of the present invention for preparing chlorine.

An oxygen-containing feed gas stream 3, an oxygen-containing recycle stream 16 and a stream 2 comprising hydrogen chloride are fed into the hydrogen chloride oxidation reactor 4 in which hydrogen chloride is catalytically oxidized to chlorine. As oxygen-containing stream, it is possible to use, for example, pure oxygen, 94% strength by volume oxygen from a pressure swing absorption (technical-grade oxygen) or oxygen-enriched air. A product gas stream 5 comprising chlorine, unreacted oxygen, unreacted hydrogen chloride and water vapor is obtained. The product gas stream 5 is introduced into a phase contact apparatus 6 and is there brought into contact with water 7, giving a stream 8 comprising dilute hydrochloric acid. A stream 23 comprising dilute hydrochloric acid introduced from the outside and the stream 8 comprising dilute hydrochloric acid are fed into a first distillation column 1 and distilled at a pressure p1 at which hydrogen chloride 2 is obtained as top product and hydrochloric acid 24 which boils azeotropically at the pressure p1 is obtained as bottom product. The hydrogen chloride stream 2 is recirculated as recycle stream to the oxidation reactor 4. Part of the hydrochloric acid 24 can be fed into the phase contact apparatus 6 as additional absorption medium stream 24a. A gas stream 9 which comprises chlorine, oxygen and water vapor and has been freed of hydrogen chloride leaves the phase contact apparatus 6 and is conveyed to a drying stage 10. In the drying stage 10, the gas stream 9 is brought into contact with a suitable absorption medium such as sulfuric acid, molecular sieves or another hydroscopic adsorbent and thus freed of traces of water. The drying stage 10 is optionally followed by a demister 12 in which the dried gas stream 10 is freed of entrained droplets of liquid. A demister is preferably provided if the drying stage 10 comprises absorption in sulfuric acid. The gas stream 13 which has been dried and optionally freed of droplets of liquid and comprises chlorine and oxygen is fed to the distillation stage 14 in which oxygen is separated off and recirculated as recycled stream 16 to the hydrogen chloride oxidation reactor. A product stream 15 comprising chlorine is obtained. To avoid accumulation of inert gas constituents such as nitrogen, argon (which may come from the oxygen-containing feed stream 3 if pure oxygen is not used) or carbon dioxide (which may come from combustion of hydrocarbons or chlorinated hydrocarbons), a purge stream 16a is provided.

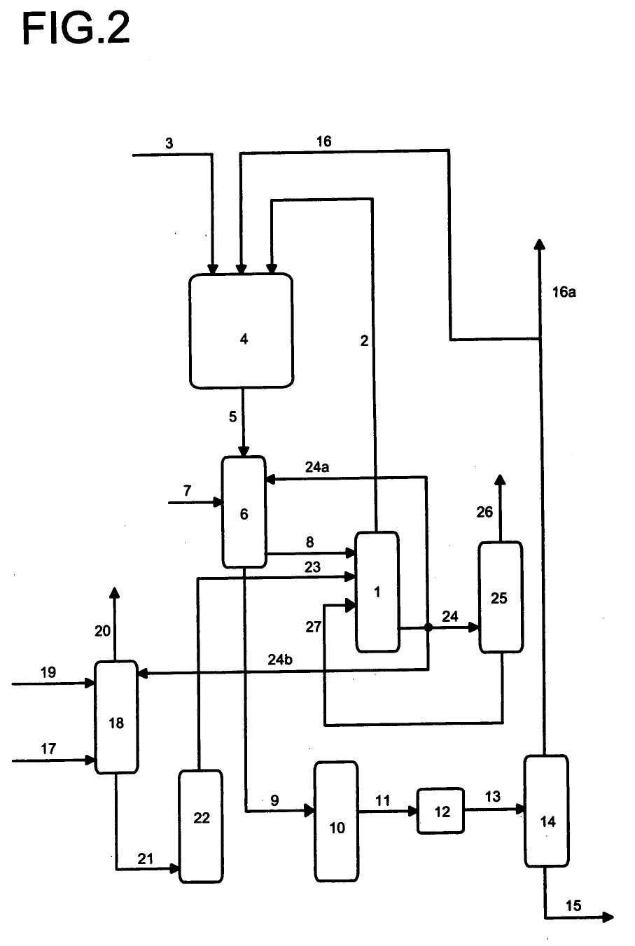

FIG. 2 shows, by way of example, a further variant of the process of the present invention for preparing chlorine.

An oxygen-containing feed gas stream 3, an oxygen-containing recycle stream 16 and a recycle stream 2 comprising hydrogen chloride are fed into the hydrogen chloride oxidation reactor 4 in which hydrogen chloride is catalytically oxidized to chlorine. As oxygen-containing stream, it is possible to use, for example, pure oxygen, 94% strength by volume oxygen from a pressure swing absorption (technical-grade oxygen) or oxygen-enriched air. A product gas stream 5 comprising chlorine, unreacted oxygen, unreacted hydrogen chloride and water vapor is obtained. The product gas stream 5 is introduced into a phase contact apparatus 6 and is there brought into contact with water 7, giving a stream 8 comprising dilute hydrochloric acid. A stream 17 comprising hydrogen chloride and gaseous secondary constituents which are not soluble in water is introduced into a phase contact apparatus 18, preferably a gas scrubber, and brought into contact with water 19, giving a stream 21 comprising dilute hydrochloric acid and an offgas stream 20 comprising the gaseous secondary constituents. The hydrochloric acid stream 21 can be freed of trace impurities which are not soluble in water and are dispersed in the hydrochloric acid by stripping with steam in the stripping column 22 to give a purified hydrochloric acid stream 23. The streams 8 and 23 comprising dilute hydrochloric acid are fed into a first distillation column 1 and distilled at a pressure p1 at which hydrogen chloride 2 is obtained as top product and hydrochloric acid 24 which boils azeotropically at the pressure p1 is obtained as bottom product. The hydrogen chloride stream 2 is recirculated as recycle stream to the oxidation reactor 4. The azeotropic hydrogen chloride stream 24 is fed to a further distillation column 25 and distilled at a pressure p2<p1 to give water vapor 26 at the top of the column and a hydrochloric acid 27 which boils azeotropically at the pressure p2 and whose concentration is higher than the concentration of the hydrochloric acid 24 is obtained at the bottom of the column. The hydrochloric acid 27 is recirculated to the first distillation column 1. Part of the hydrochloric acid 24 can be fed into the phase contact apparatus 6 as additional absorption medium stream 24a, and another part can be fed into the phase contact apparatus 18 as additional absorption medium stream 24b. A gas stream 9 which has been freed of hydrogen chloride and comprises chlorine, oxygen and water vapor leaves the phase contact apparatus 6 and is passed to a drying stage 10. In the drying stage 10, the gas stream 9 is brought into contact with a suitable absorption medium such as sulfuric acid, molecular sieves or another hygroscopic adsorbent and thus freed of traces of water. The drying stage 10 is optionally followed by a demister 12 in which the dried gas stream 10 is freed of entrained droplets of liquid. A demister is preferably provided if the drying stage 10 comprises absorption in sulfuric acid. The gas stream 13 which is has been dried and optionally freed of droplets of liquid and comprises chlorine and oxygen is fed to the distillation stage 14 in which oxygen is separated off and recirculated as recycle stream 16 to the hydrogen chloride oxidation reactor. A product stream 15 comprising chlorine is obtained. To avoid accumulation of inert gas constituents such as nitrogen, argon (which may come from the oxygen-containing feed stream 3 if pure oxygen has not been used) or carbon dioxide (which may come from combustion of hydrocarbons or chlorinated hydrocarbons), a purge stream 16a is provided.

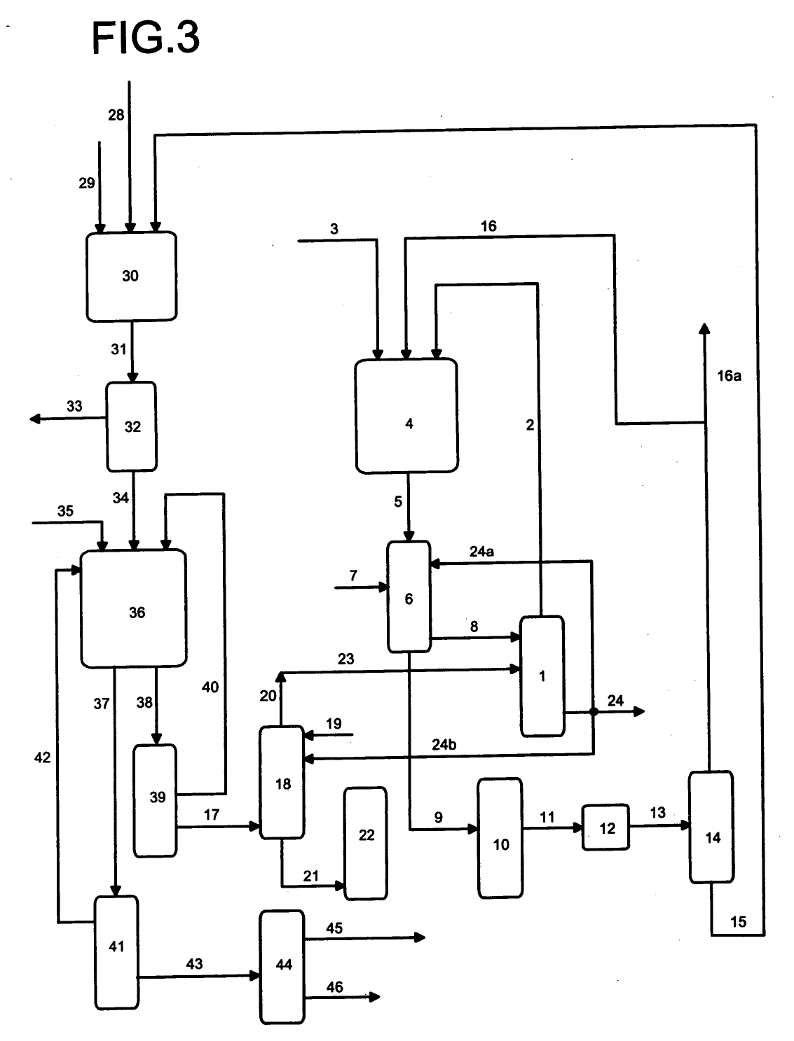

FIG. 3 shows, by way of example, a variant of the process of the present invention for preparing isocyanates.

A chlorine-containing recycle stream 15 which is obtained from the chlorine product stream from the hydrogen chloride oxidation and may have been freed of low-boiling secondary constituents by distillation in a column, a chlorine-containing supplementary stream 28 and a carbon monoxide stream 29, preferably from a synthesis gas plant, are fed to the phosgene synthesis reactor 33 and reacted there to form phosgene, with carbon monoxide preferably being used in excess. The resulting product gas stream 31, which consists essentially of phosgene and carbon monoxide and may additionally contain traces of chlorine, carbon tetrachloride and inerts such as nitrogen, is fed to the separation stage 32 and is fractionated there, preferably by condensing out phosgene or by distillation, to give an offgas stream 33 which consists essentially of carbon monoxide and may contain traces of chlorine and a stream 34 comprising phosgene. This stream 34, a stream 35 comprising a primary amine, a phosgene recycle stream 40 and a solvent recycle stream 42 are fed to the phosgenation reactor 36 where the reaction of amine with phosgene to give isocyanate and hydrogen chloride takes place. The phosgenation reactor 36 can, for example, be configured as a stirred vessel, a cascade of stirred vessels, a reaction column or a tube reactor with an upstream mixing device or a combination of the abovementioned apparatuses. The phosgenation can be carried out in two stages, viz. cold phosgenation followed by hot phosgenation. A liquid product stream 37 comprising solvent, isocyanate and by-products (e.g. urea, oligomers) is obtained and the solvent is separated off from this, preferably by distillation, in the subsequent separation stage 41. The solvent stream 42 is supplemented with fresh solvent to make up solvent losses and recirculated to the phosgenation reactor 36. The remaining isocyanate stream 43 is fractionated in the purification stage 44 to give the desired product 45 and high boilers 46. Any oligomers obtained as high boilers can also be regarded as desired product. Hydrogen chloride formed in the phosgenation reaction and excess phosgene leave the phosgenation reactor 36 as gas stream 39 which may further comprise solvent residues, low-boiling by-products, carbon monoxide, carbon dioxide and inert gases (for example nitrogen, argon). Phosgene and solvent residues are separated off from this, preferably by distillation, in the separation stage 39 and recirculated as recycle stream 40 to the phosgenation stage 36. This leaves a hydrogen chloride stream 17 which may still contain small amounts of solvent, phosgene or inerts. This is fed to the phase contact apparatus 18 and is there brought into contact with water 19, giving a stream 21 comprising dilute hydrochloric acid and an offgas stream 20 comprising the gaseous secondary constituents. Part of the hydrochloric acid 24 can be fed into the phase contact apparatus 18 as additional absorption medium stream 24b. The stream 21 is used in the process of the present invention for preparing chlorine as shown in FIG. 1.

We claim:

1. A process for preparing chlorine from hydrochloric acid, which comprises the steps:
a) providing a hydrochloric acid feed stream I;
b) providing a hydrochloric acid recycle stream II;
c) separating off a hydrogen chloride stream IV from the hydrochloric acid feed stream I and the hydrochloric acid recycle stream II in a distillation step, wherein the hydrochloric acid stream II is fractionated in a first substep c1) to give a hydrogen chloride stream IV and an azeotropic hydrochloric acid stream Ia and the azeotropic hydrochloric acid stream IIa is fractionated in a second substep c2) to give a water vapor stream IX and a hydrochloric acid stream IIb which has a concentration higher than that of IIa and the hydrochloric acid stream IIb is recirculated to the substep c1), with the first substep c1) being carried out at a higher pressure than the second substep c2),
d) feeding the hydrogen chloride stream IV, an oxygen-containing stream V and, if desired, an oxygen-containing recycle stream Va into an oxidation zone and oxidizing hydrogen chloride to chlorine in the presence of a catalyst to give a product gas stream VI comprising chlorine, unreacted oxygen, unreacted hydrogen chloride and water vapor;
e) separating off hydrogen chloride and water from the product gas stream VI in an absorption step to give a gas stream VII and the hydrochloric acid recycle stream II;
f) if desired, drying the gas stream VII;
g) separating off an oxygen-containing stream from the gas stream VII and, if desired, recirculating at least part of this as oxygen-containing recycle stream Va to the oxidation zone, leaving a chlorine-containing product stream VIII;
h) if desired, further purifying the chlorine-containing product stream VIII.

2. A process as claimed in claim 1, wherein the hydrochloric acid feed stream I is obtained by
a1) preparing a feed gas stream Ia which comprises hydrogen chloride and may contain secondary constituents which are not soluble in water;
a2) absorbing hydrogen chloride in water in an absorption step to give the hydrochloric acid feed stream I and possibly an offgas stream III comprising impurities which are not soluble in water.

3. A process as claimed in claim 1 or 2, wherein the feed gas stream Ia comprising hydrogen chloride is obtained as offgas stream in (1) isocyanate production from phosgene and amines, (2) acid chloride production, (3) polycarbonate production, (4) preparation of vinyl chloride from ethylene dichloride and/or (5) chlorination of aromatics.

4. A process as claimed in any of claims 1 to 3, wherein the pressure in the first substep is from 1 to 20 bar.

5. A process for preparing organic isocyanates, which comprises the steps
i) providing a feed gas stream X comprising carbon monoxide, a chlorine-containing recycle stream VIII and, if desired, a chlorine-containing supplementary stream VIIIa;
ii) reacting the streams X, VIII and, if used, VIIIa in a phosgene synthesis step to give a phosgene-containing gas stream XI;
iii) reacting the phosgene-containing gas stream XI with or more primary amines in an isocyanate synthesis step to form the corresponding isocyanate(s) and hydrogen chloride and give a gas stream XII comprising hydrogen chloride and unreacted phosgene and an isocyanate-containing product stream XIII;
iv) fractionating the gas stream XII comprising hydrogen chloride and unreacted phosgene in a fractionation step to give a gas stream Ia comprising hydrogen chloride and possibly impurities which are not soluble in water and a phosgene-containing stream XIV, and, if desired, recirculating the phosgene-containing stream XIV to the isocyanate synthesis step iii);
v) absorbing hydrogen chloride from the gas stream Ia in water in an absorption step to give a hydrochloric acid feed stream I comprising dilute hydrochloric acid and possibly an offgas stream III comprising the impurities which are not soluble in water;
vi) separating off a hydrogen chloride stream IV from the hydrochloric acid feed stream I and a hydrochloric acid recycle stream II in a distillation step;
vii) feeding the hydrogen chloride stream IV, an oxygen-containing stream V and, if desired, an oxygen-containing recycle stream Va into an oxidation zone and oxidizing hydrogen chloride in the presence of a catalyst to form chlorine and give a product gas stream VI comprising chlorine, unreacted oxygen, unreacted hydrogen chloride and water vapor;
viii) separating off hydrogen chloride and water from the product gas stream VI in an absorption step to give a gas stream VII and a hydrochloric acid recycle stream II comprising dilute hydrochloric acid;
ix) drying the gas stream VII;
x) separating off an oxygen-containing stream from the gas stream VII and, if desired, recirculating at least part of this as oxygen-containing recycle stream Va to the oxidation zone to leave a chlorine-containing product stream VIII;
xi) using the chlorine-containing product stream VIII, if desired after purification, as chlorine-containing recycle stream VIII in step i).

6. A process as claimed in claim 5, wherein, in the distillation step vi), the hydrochloric acid feed stream I and the hydrochloric acid recycle stream II are fractionated in a first substep vi-1) to give a hydrogen chloride stream IV and an azeotropic hydrochloric acid stream IIa and the azeotropic hydrochloric acid stream IIa is fractionated in a second substep vi-2) to give a water vapor stream IX and a hydrochloric acid stream IIb which has a concentration higher than that of IIa and the hydrochloric acid stream IIb is recirculated to the substep vi-1), with the first substep vi-1) being carried out at a higher pressure than the second substep vi-2).
